(19) United States
(12) Patent Application Publication
(10) Pub. No.: US 2009/0174704 A1
(43) Pub. Date: Jul. 9, 2009

(54) Graphics Interface And Method For Rasterizing Graphics Data For A Stereoscopic Display

(76) Inventor: Graham Sellers, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/970,598

(22) Filed: Jan. 8, 2008

(51) Int. Cl. G06T 15/00

(52) U.S. Cl. 345/419

(57) ABSTRACT

A graphics interface is operable to generate a stereoscopic image frame comprising a first set of pixels associated with a first view position and a second set of pixels associated with a second view position. The graphics interface comprises a rasterizer examining pixels of a first image to determine those pixels of the first image corresponding to pixels of the first set and examining pixels of a second image to determine those pixels of the second image corresponding to pixels of the second set and rasterizing only the determined pixels thereby to generate the stereoscopic image frame.

### FIELD OF THE INVENTION

The present invention relates generally to graphics processing and in particular, to a graphics interface and to a method for rasterizing graphics data.

### BACKGROUND OF THE INVENTION

Humans have stereoscopic vision by perceiving the world from two slightly different vantage points. Each eye sees a different view of the world, and the brain utilizes this difference to infer depth and distance and thus perceive a three-dimensional (3D) visual perspective.

Liquid crystal display (LCD) devices or panels that present stereoscopic images (i.e. images that appear three-dimensional) to viewers are emerging in the art. For example, U.S. Pat. No. 6,798,409 to Thomas et al. discloses a method and display in which a representation of a 3D model is provided for presentation as a 3D image. The image may be presented under an array of spherical or lenticular microlenses so that different images are presented at different viewing angles. The images are rendered using a set of orthographic projections.

U.S. Pat. No. 6,833,834 to Wasserman et al. discloses a graphics system that includes a frame buffer, a write address generator, and a pixel buffer. The write address generator calculates a write address for each pixel in a burst of pixels output from the frame buffer. The write address corresponds to a relative display order within the burst for each respective pixel. Each pixel in the burst is stored to its write address in the pixel buffer.

U.S. Pat. No. 6,888,540 to Allen discloses a method of generating a plurality of images for display of a 3D scene from different viewpoints. A model of the scene is generated using a homogenous coordinate system comprising first, second, and third orthogonal axes, as well as a homogeneity value. A first display image is obtained from a first viewpoint and one or more further display images are obtained by updating a coordinate value of the first display image using a displacement value and the homogeneity value. The use of the homogeneity value reduces the complexity of the calculations required to obtain the further images by post processing.

U.S. Patent Application Publication No. US 2002/0154145 to Isakovic et al. discloses an apparatus and method for image data computation and synchronous data output. It also discloses an arrangement for producing and reproducing two partial light images which together can be perceived as a light image having a three-dimensional effect. The apparatus has a master-client structure comprising a graphics master and at least two graphics clients connected together by way of a first message channel that is used for exchanging first messages thereby to allow computation and projection of the partial light images to be synchronized.

U.S. Patent Application Publication No. US 2004/0085310 to Snuffer discloses a system and method for extracting and processing three-dimensional graphics data generated by OpenGL or other API-based graphics applications for conventional two-dimensional monitors so that the graphics data can be used to display three-dimensional images on a 3D volumetric display system. An interceptor module intercepts instructions sent to OpenGL and extracts data based on the intercepted instructions for use by the 3D volumetric display system.

U.S. Patent Application Publication No. US 2004/0179262 to Harmon et al. discloses a method of generating images suitable for use with a multi-view stereoscopic display. Data representing a scene or object to be displayed that is passed from an application to an application programming interface is intercepted. The intercepted data is processed to render multiple views before being passed to the application programming interface.

U.S. Patent Application Publication No. 2004/0257360 to Sieckmann discloses a device for imaging a three-dimensional (3D) object as an object image. The device comprises an imaging system including a microscope for imaging the object, and a computer communicating with the imaging system. Actuators change the position of the object in the x, y and z direction in a specific and rapid manner. A recording device records a stack of individual images in different focal levels of the object. A control device controls the hardware of the imaging system, and an analytical device produces a three-dimensional relief image and a texture from the image stack. The control device also combines the three-dimensional relief image with the texture.

U.S. Patent Application Publication No. 2005/0117637 to Routhier et al. discloses a system for processing a compressed stereoscopic image stream. The compressed image stream has a plurality of frames in a first format, each frame consisting of a merged image comprising pixels sampled from a left image and pixels sampled from a right image. A receiver receives the compressed image stream and a decompressing module in communication with the receiver decompresses the compressed image stream prior to the decompressed image stream being stored in a frame buffer. A serializing unit reads pixels of the frames stored in the frame buffer and outputs a pixel stream comprising pixels of the left and right images of the frames. A stereoscopic image processor receives the pixel stream, buffers the pixels, performs interpolation in order to reconstruct pixels of the left and right images and outputs a reconstructed left pixel stream and a reconstructed right pixel stream. The reconstructed left and right pixel streams have a format different than the first format. A display signal generator receives the reconstructed left and right pixel streams to provide an output display signal.

U.S. Patent Application Publication No. 2005/0122395 to Lipton et al. discloses a system and method for interdigitating multiple perspective views in a stereoscopic image viewing system. A lenticular sheet is affixed in intimate juxtaposition with a display area having a defined aspect ratio. The display area includes a plurality of scan lines, each scan line comprising a plurality of pixels and with each pixel including subpixels. A map having the same resolution as the display area is created to store values corresponding to each subpixel in the display area. The map is generated beforehand and stored for later use through a lookup operation. A buffer stores a frame having n views, wherein each of the ‘n’ views has the same aspect ratio as the display area. A plurality of masks is also created and stored. Each mask corresponds to a unique one of the ‘n’ views and includes opaque areas and a plurality of transparent windows. The ‘n’ views are interdigitated while applying the corresponding masks, and a value is assigned to each subpixel using the map.

Although techniques for rasterizing graphics data exist, improvements are desired. It is therefore an object of the present invention at least to provide a novel graphics interface and method for rasterizing graphics data.

### SUMMARY OF THE INVENTION

Accordingly, in one aspect there is provided a graphics interface operable to generate a stereoscopic image frame comprising a first set of pixels associated with a first view position and a second set of pixels associated with a second view position, said graphics interface comprising a rasterizer examining pixels of a first image to determine those pixels of the first image corresponding to pixels of said first set and examining pixels of a second image to determine those pixels of the second image corresponding to pixels of said second set and rasterizing only the determined pixels thereby to generate said stereoscopic image frame.

In one embodiment, the first set of pixels is designated for viewing by a viewer's left eye and the second set of pixels is designated for viewing by a viewer's right eye. The first set of pixels and the second set of pixels are interleaved such that each row and each column of pixels of the stereoscopic image frame includes an equal number of pixels from the first and second sets. Each row and each column of pixels of the stereoscopic image frame also comprises alternating pixels from the first and second sets.

In one embodiment, the rasterizer examines pixels forming graphics primitives constructed from the first and second images. A per-fragment operations module communicates with the rasterizer and processes fragments resulting from rasterized pixels. Memory stores processed fragments.

According to another aspect, there is provided a method of rasterizing graphics data forming a three-dimensional image frame for presentation on a display. The display has a first set of pixels associated with a first view position and a second set of pixels associated with a second view position. The method comprises examining pixels of a first image to determine the pixels of the first image corresponding to pixels of the first set and examining pixels of a second image to determine the pixels of the second image corresponding to pixels of the second set. The determined pixels of the first and second sets are rasterized.

According to yet another aspect, there is provided a computer-readable medium embodying machine-readable code for rasterizing graphics data forming a three-dimensional image frame for presentation on a display. The machine-readable code comprises machine-readable code for examining pixels of a first image to determine the pixels of the first image corresponding to pixels of the first set, machine-readable code for examining pixels of a second image to determine the pixels of the second image corresponding to pixels of the second set and machine-readable code for rasterizing the determined pixels of the first and second sets.

### BRIEF DESCRIPTION OF THE DRAWINGS

Embodiments will now be described more fully with reference to the accompanying drawings in which:

FIGS. 1A and 1B are block diagrams of prior art 3D graphics systems;

FIG. 2 is a block diagram of a 3D graphics system for rasterizing graphics data;

FIG. 3 is an block diagram of the 3D graphics system of FIG. 2 better illustrating components of its display hardware;

FIG. 4 is a pixel map of an LCD panel forming part of the 3D graphics system of FIG. 2;

FIG. 5 shows left and right images that are combined to generate a stereoscopic image frame;

FIG. 6 is a flowchart of a method of driving the LCD panel of FIG. 4; and

FIG. 7 is a schematic block diagram of an alternative 3D graphics system for rasterizing graphics data.

### DETAILED DESCRIPTION OF THE EMBODIMENTS

As discussed above, software tools and libraries that enable the display of three-dimensional (3D) images exist. For example, OpenGL is an industry standard graphics application programming interface (API) for two-dimensional (2D) and three-dimensional (3D) graphics applications. In general, the OpenGL API processes graphics data representing objects to be rendered that are received from a host application (e.g., computer aided design (CAD) software, video games, 3D user interfaces, etc.), and renders graphical objects on a display device for viewing. The graphics data for each graphical object to be rendered comprises an array of 3D coordinates and associated data, commonly referred to as vertices. The graphical object vertices are represented as four-element homogenous vectors [x, y, z, w], where x, y, and z are the vertex coordinates in 3D space and w is one (1). When the graphical object vertices for a graphical object are received, the OpenGL API transforms the graphical object vertices and constructs graphics primitives by grouping sets of graphical object vertices together to form points, lines, triangles and polygons. The constructed graphics primitives are then rendered into a bitmap for display on the display device.

In its current form, the OpenGL API provides support for traditional stereoscopic displays, where for each image frame to be displayed, left and right versions of an image, each having a separate vantage relative to the same 3D space, are generated for independent presentation to each eye of a viewer via specialized hardware. The hardware used to present the left and right images of the image frame to the viewer may take different forms depending on the type of stereoscopic display. For example, the left and right images may be presented to the viewer's eyes using two small head-mounted display panels, each of which presents a respective one of the left and right images. Alternately, the left and right images may be presented on a single monitor in an alternating fashion. In this case, using special (polarized) glasses, during display of the left image the right eye is blocked and during display of the right image the left eye is blocked. As will be appreciated, irrespective of the hardware used to present the left and right images of the image frame to the viewer, complete and separate left and right images for each image frame are generated and displayed. Unfortunately, the process of rendering two complete versions of each image for every image frame results in everything being drawn twice, which is computationally and memory expensive.

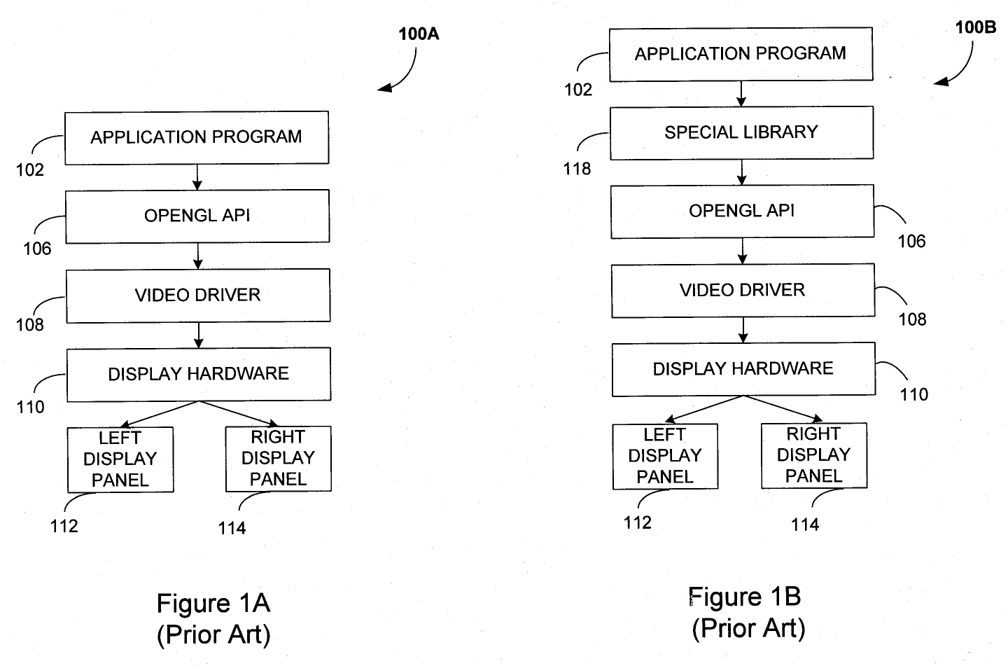

Turning now to FIGS. 1A and 1B, block diagrams of prior art 3D graphics systems that are adapted to render 3D graphics images are shown. Referring to FIG. 1A, graphics system 100A comprises an application program 102 such as for example a video game, an OpenGL application program interface (API) 106 for providing 3D graphics libraries to the application program 102 for facilitating the rendering of the 3D graphics images, a video driver 108, display hardware 110 (e.g., a graphics processing unit (GPU)), and left and right display panels 112 and 114, each of which is aligned with a corresponding eye of the viewer. The video driver 108 provides interfacing between the OpenGL API 106 and the display hardware 110. Using the application program 102 and OpenGL API, 3D graphics images are formatted by the display hardware 110 in order to generate two different versions of the same image, each image having a different vantage relative to the same 3D space (i.e., left and right images) for each image frame to be displayed. The generated left and right images are then applied to the corresponding display panels 112 and 114 and presented to the viewer's eyes so that the viewer perceives a 3D image. FIG. 1B shows another 3D graphics system 100B that is similar to the 3D graphics system 100A shown in FIG. 1A. In this embodiment, in addition to the application program 102, OpenGL API 106, video driver 108, display hardware 110 and left and right display panels 112 and 114, graphics system 100B also comprises a special library module 118 that provides additional 3D graphics libraries for creating graphics primitives of an increased complexity thereby to enable more sophisticated 3D image renderings to be generated.

Although the graphics systems 100A and 100B have been described above as comprising left and right display panels 112 and 114 respectively, as mentioned previously the graphics systems 100A and 100B may alternately comprise a single display panel. In this case, the complete left and right images of each image frame are displayed by the display panel in an alternating fashion. Polarized glasses worn by the viewer block the viewer's left eye during display of the right image and block the viewer's right eye during display of the left image so that the viewer perceives the 3D image.

As will be appreciated, irrespective of the display hardware employed, for each image frame to be displayed, the graphics systems 100A and 100B generate and display two complete versions of the same image. This results in an increase in net processing and memory requirements.

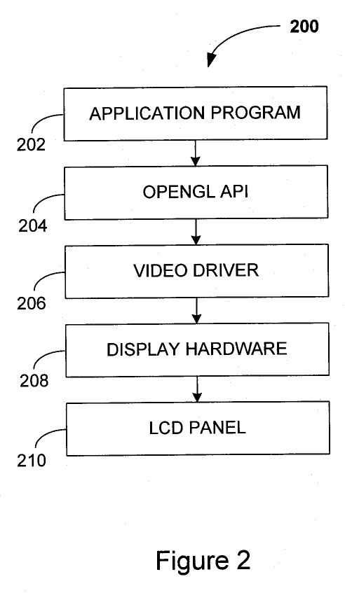

Referring now to FIG. 2, a graphics system 200 is shown and comprises an application program 202 such as for example a video game, an OpenGL application program interface (API) 204 for providing 3D graphics libraries to the application program 202 to facilitate the rendering of 3D graphics images, a video driver 206, display hardware 208 (e.g., a GPU), and a liquid crystal display (LCD) panel 210. The video driver 206 provides interfacing between the OpenGL API 204 and the display hardware 208. Using the application program 202 and OpenGL API 204, 3D graphics images are formatted by the display hardware 208 in order to generate stereoscopic image frames for presentation by the LCD panel 210.

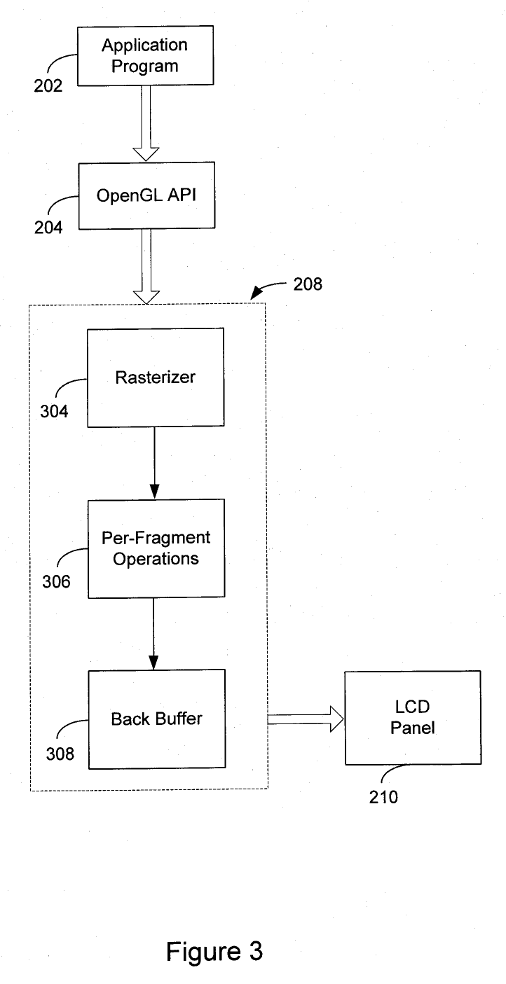

FIG. 3 better illustrates the components of the display hardware 208. As can be seen, display hardware 208 comprises a hardware rasterizer 304, a per-fragment operations module 306, and a back buffer 308. The rasterizer 304 converts graphics primitives into fragments for processing by the per-fragment operations module 306 if required. Each fragment comprises color, texture, coordinate, depth and back buffer location values. The per-fragment operations module 306 subjects the fragments requiring processing to one or more tests and modifications including but not limited to, a stencil test, a depth test, and blending. Fragments not requiring processing and fragments processed by the per-fragment operations module 306 are written to the back buffer 308 to form a resultant bitmap prior to being output to the LCD panel 210. The back buffer 308 in this embodiment comprises a rectangular array of bit-planes organized into a plurality of logical buffers. To reduce net processing and memory requirements, the display hardware 208 only rasterizes pixels of the left and right images that form part of the stereoscopic image frame to be viewed as will be described.

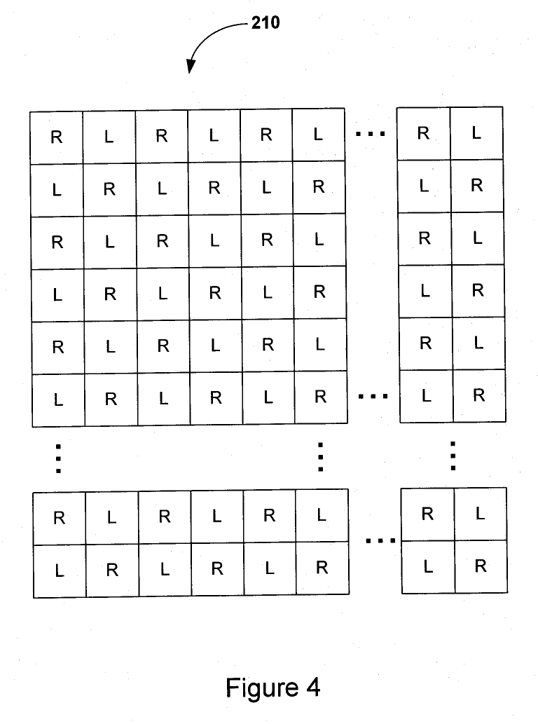

FIG. 4 shows a pixel map of the LCD panel 210. In this embodiment, the LCD panel 210 is similar to that developed by Sanyo Epson Imaging Devices® (SEID). Pixels of the LCD panel 210 that are designated for visibility by the right eye of a viewer are marked with an ‘R’, and pixels of the LCD panel 210 that are designated for visibility by the left eye of the viewer are marked with an ‘L’. The right eye and left eye pixels R and L are interleaved to form a checkerboard pattern, which facilitates the generation of a 3D display effect from a viewer's perspective. For this checkerboard pattern, in any given pixel row or pixel column of the LCD panel 210, fifty (50) percent of the pixels are right eye pixels R, and fifty (50) percent of the pixels are left eye pixels L. LCD panel 210 also comprises a filter (not shown) that includes a grid of barriers that cover the pixels of the LCD panel. The filter allows light from each pixel of the LCD panel 210 to be visible only from particular directions. When the viewer is in a proper viewing position relative to the LCD panel 210, the left eye pixels L are viewable only by the viewer's left eye and the right eye pixels R are viewable only by the viewer's right eye. As a result, at such a viewing position, when a stereoscopic image frame is presented by the LCD panel 210, the viewer sees two different versions of the same image since the left eye sees an image formed by the left eye pixels L and the right eye sees an image formed by the right eye pixels R. This allows for the generation of a 3D image from the viewer's visual perspective without requiring two complete versions of the same image to be displayed.

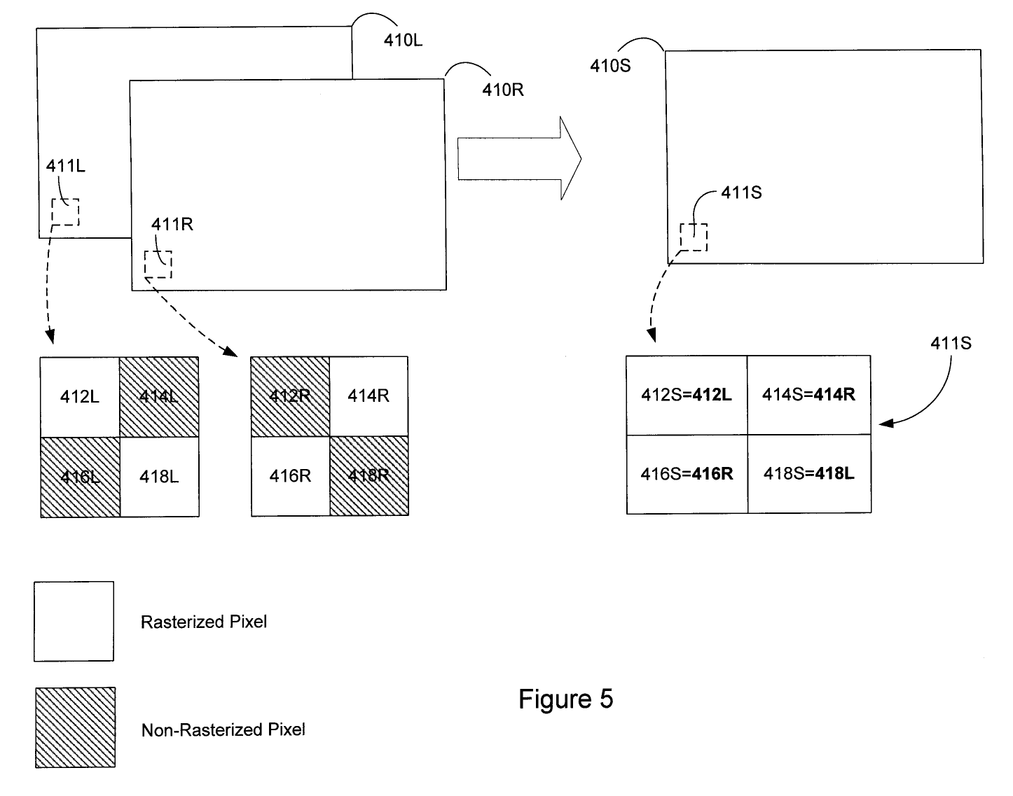

In general, during operation when the graphics system 200 is to display a stereographic image frame, similar to prior art graphics systems, the application program 202 in conjunction with the OpenGL API 204 generates left and right monoscopic versions of the same image with each image having a different vantage relative to the same 3D space. To limit data processing, only pixels of each image that are to form part of the stereoscopic image frame displayed on the LCD panel 210 and be seen by the viewer are rasterized. As a result, one half of the data in each image is discarded, since each image is used to drive only one half of the pixels of the LCD panel 210. The rasterized pixels of the two images are then combined by the display hardware 208 to yield the stereoscopic image frame for display. For example, as illustrated in FIG. 5, monoscopic left image 410L and monoscopic right image 410R, that are combined to produce a single stereoscopic image frame 410S for display are shown. Insets 411L and 411R highlight the four lower leftmost pixels of the images 410L and 410R respectively. Inset 411L comprises pixels 412L, 414L, 416L and 418L and inset 411R comprises pixels 412R, 414R, 416R and 418R. Only pixels 412L and 418L of inset 411L are rasterized and only pixels 414R and 416R of inset 411R are rasterized. Pixels 414L, 416L, 412R and 418R are discarded. The rasterized pixels of the images 410L and 410R are combined to yield stereoscopic image frame 410S. In the stereoscopic image frame 410S, the inset 411S comprises pixels 412L, 414R, 416R, and 418L. As will be appreciated, the stereoscopic image frame 410S has a checkerboard distribution of rasterized pixels from the left and right images 410L and 410R.

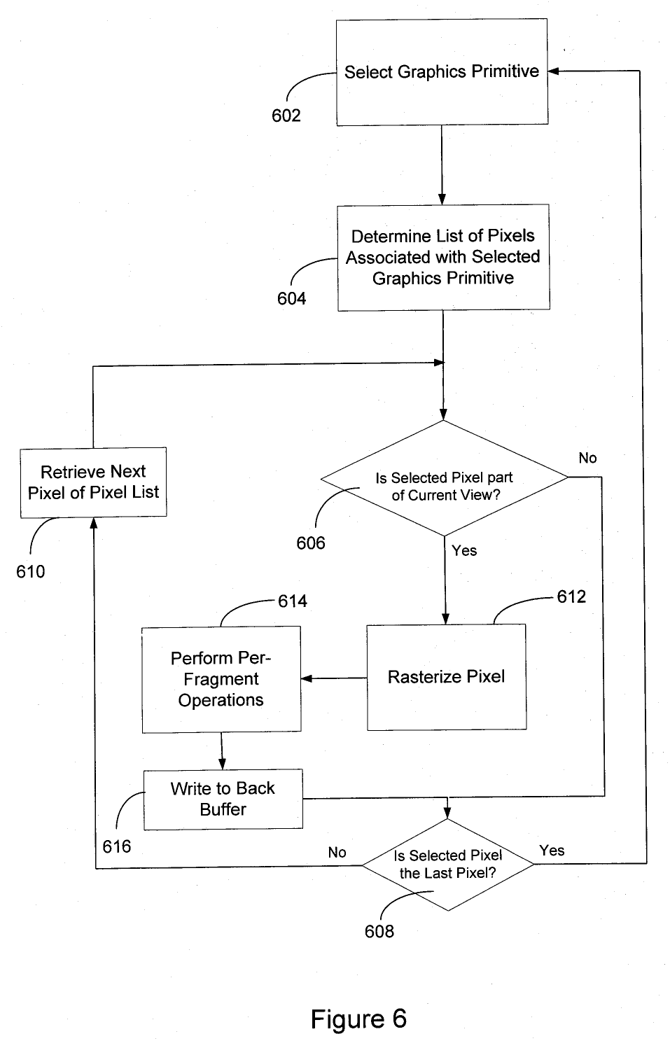

When the graphics system 200 is to generate a stereoscopic image frame for display on the LCD panel 210, the OpenGL API 204 transforms the graphical object vertices of the graphical objects forming the complete left and right images and constructs graphics primitives for the left and right images by grouping sets of the transformed graphical object vertices. As only a subset of each left and right image forms part of the stereoscopic image frame to be displayed, in order to reduce data processing, only pixels forming graphics primitives that are to be seen by the viewer when the stereoscopic image frame is displayed are rendered into the bitmap. FIG. 6 better illustrates the steps performed by the graphics system 200 during rendering of the graphics primitives.

Initially, with the graphics primitives of the left and right images constructed, one of the graphics primitives is selected (step 602). At step 604, a list of the pixels forming the selected graphics primitive is determined. The pixel list may be generated using one of a number of algorithms that execute a ‘bounding box’ routine. Use of the bounding box routine avoids the processing of each and every pixel in the image in order to determine the pixels occupied by the selected graphics primitive. Once the list of pixels has been generated, the first pixel in the list is selected and a check is made to determine whether that pixel is positioned at a location which will be seen by the viewer when the stereoscopic image frame is displayed (step 606). For example, if the selected graphics primitive forms part of the left image, the selected pixel is examined to determine if its location corresponds to one of the left eye pixels L of the LCD panel 210. If the selected graphics primitive forms part of the right image, the selected pixel is examined to determine if its location corresponds to one of the right eye pixels R of the LCD panel 210. At step 606, if the selected pixel is positioned at a location that will not form part of the stereoscopic image frame to be displayed, the selected pixel is discarded. A check is then made to determine if the selected pixel is the last pixel in the list (step 608). If the selected pixel is determined to be the last pixel in the list, the rendering process for the selected graphics primitive is deemed complete at which point the next graphics primitive is selected (step 602). If the selected pixel is not the last pixel in the list, the next pixel in the list is selected at step 610 and the process reverts back to step 606.

At step 606, if the selected pixel is positioned at a location that forms part of the stereoscopic image frame to be displayed, the selected pixel is rasterized (step 612) by the rasterizer 304. The resulting fragments are then subjected to per-fragment operations if required (step 614) prior to being written to the back buffer 308 (step 616). Following step 616, the process proceeds to step 608 where a check is made to determine if the selected pixel is the last pixel in the list of pixels. If the selected pixel is determined to be the last pixel in the list, the rendering process for the selected graphics primitive is deemed complete at which point the next graphics primitive is selected (step 602). If not, the next pixel in the list is selected at step 610 and the process reverts back to step 606. As will be appreciated, only pixels of graphics primitives that will be seen when the stereoscopic image frame is displayed on LCD panel 210 are rasterized. This of course reduces processing and memory requirements.

Although the rasterizer 304 is described above as being a hardware rasterizer within display hardware 208, the rasterizer 304 may be implemented as a software module located within either the video driver 206 or the OpenGL API 204.

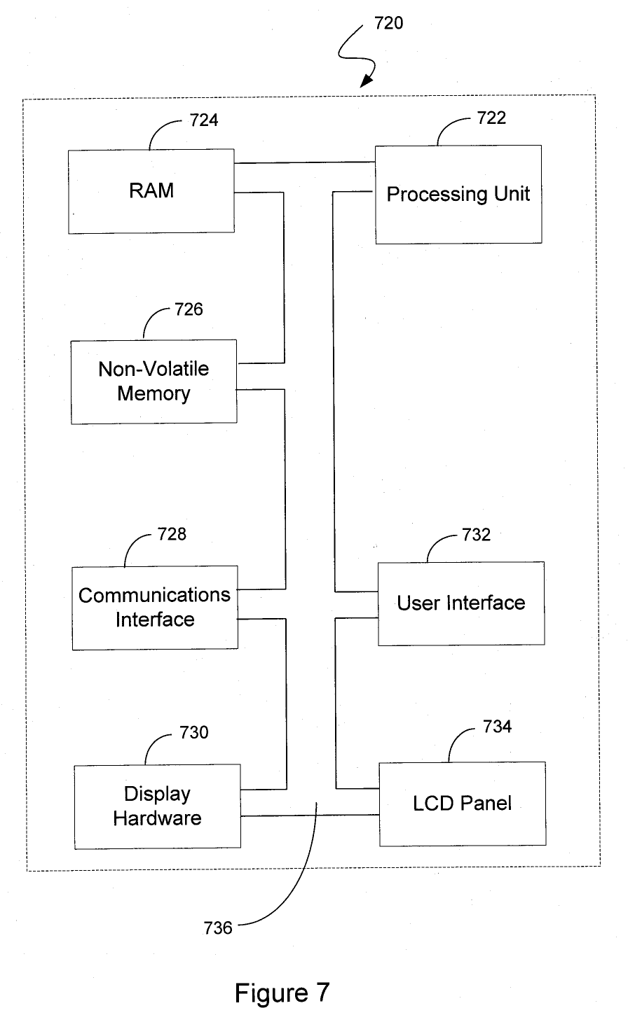

Turning now to FIG. 7, another graphics system 720 for rasterizing 3D images is shown. In this embodiment, the graphics system 720 rasterizes pixels associated with 3D images (e.g., one or more graphics primitives) according to commands received from an application program utilizing the OpenGL 3D graphics libraries. As illustrated, the graphics system 720 comprises a processing unit 722 (e.g., a CPU or GPU), random access memory (“RAM”) 724, non-volatile memory 726, a communications interface 728, display hardware 730, a user interface 732 and an LCD panel 734 similar to LCD panel 210, all in communication over a local bus 736. The processing unit 722 retrieves a rasterization software application program from the non-volatile memory 726 into the RAM 724 for execution by the processing unit 722. The rasterization software application program renders graphics primitives in a manner similar to that shown in FIG. 6 and the resultant bitmap is presented on the LCD panel 734. Via user interface 732, a viewer may elect to transfer the 3D rendered images to the non-volatile memory 726, or to one or more remote storage devices and/or remote displays by means of communications interface 728. The non-volatile memory 726 may also store additional software applications that may be used to support other graphics processing operations.

The rasterizing software application may include program modules including routines, programs, object components, data structures etc. and be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable program code can also be distributed over a network including coupled computer systems so that the computer readable program code is stored and executed in a distributed fashion.

Although embodiments have been described, those of skill in the art will appreciate that variations and modifications may be made without departing from the spirit and scope thereof as defined by the appended claims.

What is claimed is:

1. A graphics interface operable to generate a stereoscopic image frame comprising a first set of pixels associated with a first view position and a second set of pixels associated with a second view position, said graphics interface comprising a rasterizer examining pixels of a first image to determine those pixels of the first image corresponding to pixels of said first set and examining pixels of a second image to determine those pixels of the second image corresponding to pixels of said second set and rasterizing only the determined pixels thereby to generate said stereoscopic image frame.

2. The graphics interface according to claim 1, wherein said first set of pixels is designated for viewing by a viewer's left eye and said second set of pixels is designated for viewing by a viewer's right eye.

3. The graphics interface according to claim 2, wherein said first set of pixels and said second set of pixels are interleaved such that each row and each column of pixels of said stereoscopic image frame includes an equal number of pixels from said first and second sets.

4. The graphics interface according to claim 3 wherein each row and each column of pixels of said stereoscopic image frame comprises alternating pixels from said first and second sets.

5. The graphics interface according to claim 2 wherein said rasterizer examines pixels forming graphics primitives constructed from said first and second images.

6. The graphics interface according to claim 5 further comprising a per-fragment operations module communicating with said rasterizer, said per-fragment operations module processing fragments resulting from rasterized pixels.

7. The graphics interface according to claim 6 further comprising memory storing processed fragments.

8. The graphics interface according to claim 5 further comprising memory communicating with said rasterizer.

9. The graphics interface according to claim 7, wherein said memory comprises a back buffer.

10. A method of rasterizing graphics data forming a three-dimensional image frame for presentation on a display, said display having a first set of pixels associated with a first view position and a second set of pixels associated with a second view position, said method comprising:
examining pixels of a first image to determine the pixels of said first image corresponding to pixels of said first set;
examining pixels of a second image to determine the pixels of said second image corresponding to pixels of said second set; and
rasterizing the determined pixels of said first and second sets.

11. The method of claim 10 wherein during said examining, pixels forming graphics primitives of said first and second images are examined.

12. The method of claim 11 further comprising subjecting the rasterized pixels to fragment operations.

13. The method of claim 12 further comprising storing the rasterized pixels following fragment operations in memory thereby to form a resultant bitmap.

14. The method of claim 11 further comprising storing the rasterized pixels.

15. The method according to claim 14, further comprising displaying said first set of pixels to a viewer's left eye and displaying said second set of pixels to a viewer's right eye.

16. A computer-readable medium embodying machine-readable code for rasterizing graphics data forming a three-dimensional image frame for presentation on a display, said machine-readable code comprising:
machine-readable code for examining pixels of a first image to determine the pixels of the first image corresponding to pixels of said first set;
machine-readable code for examining pixels of a second image to determine the pixels of the second image corresponding to pixels of said second set; and
machine-readable code for rasterizing the determined pixels of said first and second sets.
